(19) United States
(12) Patent Application Publication
(10) Pub. No.: US 2021/0301529 A1
(43) Pub. Date: Sep. 30, 2021

(54) SYSTEMS AND METHODS FOR ADHERING CLADDING

(71) Applicant: NEXII BUILDING SOLUTIONS INC., Vancouver (CA)

(72) Inventors: Michael Anthony DOMBOWSKY, Moose Jaw (CA); Benedict John DOMBOWSKY, Moose Jaw (CA); Mark Benedict DOMBOWSKY, Moose Jaw (CA); Braden Louis DOMBOWSKY, West Kelowna (CA)

(21) Appl. No.: 17/217,764

(22) Filed: Mar. 30, 2021

Related U.S. Application Data
(60) Provisional application No. 63/002,142, filed on Mar. 30, 2020.

(51) Int. Cl. E04C 2/288; E04F 13/08; B32B 13/04; B28B 1/16; B28B 11/04

(52) U.S. Cl. CPC E04C 2/288; E04F 13/0875; E04C 2002/005; B28B 1/16; B28B 11/04; B32B 13/04

(57) ABSTRACT

System and method of applying cladding to a wall surface comprising applying a cementitious layer to the wall surface, the cementitious layer bonding to the wall surface, and apply a layer of cladding to the cementitious layer, the cladding bonding to the cementitious layer. The wall surface may comprise a panel and, in particular, a prefabricated panel. The cementitious layer may be a structural layer of the prefabricated panel.

### CROSS-REFERENCE TO RELATED APPLICATIONS

This application claims the benefit under 35 U.S.C. § 119 of U.S. application No. 63/002,142 filed 30 Mar. 2020 and entitled SYSTEMS AND METHODS FOR ADHERING CLADDING which is hereby incorporated herein by reference for all purposes.

### TECHNICAL FIELD

The invention relates to adhering cladding and finishes to walls, panels and structures.

### BACKGROUND

After a building has been erected it may be necessary or desirable to apply a cladding such as siding, veneers or finishes to an exterior surface of the building. Some cladding can serve a functional purpose by providing additional insulation or protection of the building from the elements. Cladding typically serves an aesthetic purpose as a finish for the exterior. Different types and appearances of finishes are used to give different aesthetics to the final building or structure.

Siding, veneers and finishes may be applied to a structure post-construction or during construction. For example, cladding may be applied in stages as the building is completed. Some existing siding materials include wood, stone, plastic, asphalt, imitation brick, vinyl, insulated siding, metal sidings such as copper, aluminium or steel, stone veneers and composites. Some composites include asphalt shingles, asbestos, fiber cement, aluminum composites, fiberboard, and hardboard. Siding might typically be applied as pieces or panels such as in the form of small shingles or larger boards and fixed to a wall. Many forms of cladding require manual skilled labour to attach the cladding to the structure.

Finishes include materials like stucco which may be applied as a coating directly over the exterior surface of a wall or plastered onto a lath or wire mesh attached to the wall. The lath or wire mesh may provide a lattice by which the wet stucco is supported as it dries or sets. Hording and scaffolding may be required to apply these materials in rain or cold weather.

Conventional cladding may require substantial labour to adhere or fasten the cladding securely to the walls of structures. Some methods require that construction of a building be wholly complete before a cladding can be applied, therefore extending the duration of the construction.

One method of constructing buildings is to use prefabricated panels. Existing buildings made from prefabricated panels may still require the application of cladding after all the buildings panels have been erected and installed, similarly extending the duration of the construction.

There remains a need for practical, efficient, and cost effective ways to apply cladding to buildings and wall surfaces such as prefabricated panels that improves on existing technologies.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

This invention has a number of aspects. These include, without limitation:
applying cladding to a panel such as a prefabricated panel by bonding the cladding directly to a structural cementitious layer of the wall panel during fabrication of the panel;
applying cladding to a wall panel by bonding the cladding to a cementitious layer of the panel, the cementitious layer itself bonding to a layer of the wall panel;
applying cladding to a panel by bonding or embedding mounting structures such as tracks, rails or furring strip into a cementitious layer of the panel and attaching the cladding to the mounting structures;
applying a liquid coating of a cladding material to a cementitious layer of the panel; and
after the application of a cladding layer, applying a post-processing layer of a material such as paint or acrylic stucco.

In an aspect of the invention a prefabricated panel comprises an insulative core having first and second opposing faces, a first cementitious layer covering at least a portion of the first face of the insulative core, and a cladding layer covering at least a portion of the first cementitious layer, the first cementitious layer bonded to the cladding layer.

In some aspects of the invention, the prefabricated building panel may comprise: a second cementitious layer covering at least a portion of the second face of the insulative core and a second cladding layer, the second cladding layer bonded to the second cementitious layer.

In an aspect of the invention, a method for adhering a cladding layer to a prefabricated panel comprises: providing a panel structure within a casting bed; applying a layer of cementitious material to cover at least a portion of a layer of the panel structure; chemically adhering a cladding material to the layer of cementitious material; and allowing the cementitious material to set.

In some aspects of the method the panel structure may comprise an insulative core having first and second opposing faces and a first cementitious layer covering at least a portion of the first face of the insulative core.

In some aspects of the method: applying a layer of cementitious material to cover at least a portion of a top layer of the panel structure comprises applying a second cementitious layer to at least a portion of the second face of the insulative core; the layer of cementitious material comprises a structural layer of the panel structure.

In some aspects of the method the step of providing a panel structure within a casting bed comprises the steps of: casting an interior layer of cementitious material and applying an insulative core to the interior layer of cementitious material.

In some aspects of the method: applying a layer of cementitious material to cover substantially all of a top layer of the panel structure comprises covering the insulative core with an exterior layer of cementitious material; the layer of cementitious material comprises a structural layer of a prefabricated panel. In some embodiments the layer of cementitious material is between ⅛″ to 2″ thick. In some embodiments the layer of cementitious material is between 0.5″ to 1.5″ thick.

In some aspects the method may comprise applying a post-processing layer to the cladding material and the post-processing layer may comprise paint or acrylic stucco.

In an aspect, a method is provided for bonding a cladding layer to a prefabricated panel, the method comprising: placing a cladding material within a casting bed; laying a layer of wet cementitious material in the casting bed, the wet cementitious material bonding to the cladding material; and applying one or more other layers of a panel structure to the wet cementitious material to form a prefabricated panel.

In a further aspect there is a method for adhering cladding to a wall, the method comprising: applying a layer of cementitious material to an exterior surface of the wall; adhering a cladding layer to the layer of cementitious material; and permitting the cementitious material to set.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1A is a perspective view of a prefabricated panel structure in a casting bed in which the walls of the casting bed nearest the viewpoint are shown as transparent for ease of illustration.

FIG. 1B is an exploded view of the prefabricated panel structure of FIG. 1A.

FIG. 1C is a cross-sectional view of the prefabricated panel structure of FIG. 1A through the line A-A.

FIG. 1D is an expanded view of detail D from FIG. 1C.

FIG. 2A is a perspective view of a partially fabricated panel showing an interior cladding layer in a casting bed in which the walls of the casting bed nearest the viewpoint are shown as transparent for ease of illustration.

FIG. 2B is a cross-sectional view of the prefabricated panel structure of FIG. 2A through the line C-C.

FIG. 3A is a perspective view of a partially fabricated panel showing an interior cladding layer and interior cementitious layer in a casting bed in which the walls of the casting bed nearest the viewpoint are shown as transparent for ease of illustration.

FIG. 3B is a cross-sectional view of the prefabricated panel structure of FIG. 3A through the line B-B.

FIG. 4A is a cross-sectional view of a partially fabricated panel structure showing an interior cementitious layer and an insulative core.

FIG. 4B is a cross-sectional view of the partially fabricated panel structure of FIG. 4A with an exterior cementitious layer.

FIG. 4C is a cross-sectional view of the partially fabricated panel structure of FIG. 4B with an exterior cladding layer.

FIG. 5 is an isometric view of a prefabricated panel showing an interior cladding layer.

FIG. 6 is an isometric view of a prefabricated panel showing an exterior cladding layer.

FIG. 7 is a flow chart diagram illustrating a method according to an example embodiment of the invention.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Broadly, embodiments of the invention relate to applying one or more cladding layers to a wall surface by bonding a cementitious layer onto the wall surface and bonding a cladding layer directly to the cementitious layer. Cladding may comprise siding, finishes, and veneers. Cladding may be wholly ornamental or may provide some beneficial properties such as improvements in sound or heat insulation. Some cladding materials may help retain heat in a building whereas other materials may help deflect heat in some climates. Claddings may also provide one or more of bullet-proofing, blast protection, and deflection or attenuation of electromagnetic radiation. Some cladding may be designed to improve water tightness or may add a rain screen effect to the exterior of the wall surface.

Methods by which these layers may be applied may be affected by the orientation and topography of the surface. In the case of a flat, planar wall the orientation can be understood as the orientation of the plane of the wall surface. In the case of a wall surface with an uneven, textured or curved surface a plane may be defined by the average elevation of the surface and an orientation of the wall surface may be understood as the orientation of that plane. A wall surface is horizontal when both axes defining the plane of the wall are horizontal. A wall surface is approximately horizontal when both axes defining the plane of the wall are approximately horizontal. As an example, a wall may be horizontal because it is in a state prior to being erected. Such a wall could include a prefabricated panel at the fabrication stage, in storage, in transportation or at a construction site.

With a wall surface that is horizontal—or approximately horizontal—and substantially flat, a cladding layer may be applied to the wall surface on top of a cementitious layer. In some circumstances, a wall surface that is horizontal but uneven (non-flat) may receive a cementitious layer up to a horizontal and flat level, with the resulting cementitious layer having a non-uniform depth. In either of the above circumstances a cementitious layer can be laid or poured on the wall surface into a layer. A cladding layer may then be applied to the cementitious layer.

A wall surface that can receive cladding in a horizontal orientation could include wall surfaces that, while they may be erected into a vertical orientation at some later stage, may be fabricated, stored, or transported in a horizontal orientation. Examples include structural insulated panels (SIPs), pre-cast concrete panels and other types of prefabricated panels.

In some embodiments, the wall surface to which the cementitious layer is applied is a panel structure 10. Panel structure 10 might comprise any of a pre-cast concrete slab, a structural insulated panel or other types of prefabricated panels. Panel structure 10 may be a substantially complete panel with all of its component parts and layers assembled with the exception of an exterior finish. In some embodiments, panel structure 10 may be a partially assembled panel.

Cladding layers may be applied to a panel as an early or initial layer of a panel structure 10 during a fabrication process, as a later layer in a later stage of fabrication of a panel structure 10, or both. For example, cladding may be the first or bottommost layer within a casting bed 12 with a layer of cementitious material cast over the bottom cladding layer. In embodiments in which cladding layers are applied to the bottommost and topmost layers of a panel structure, this may be done so that an interior cladding layer 14 is applied as the bottommost layer bonding to an interior surface of panel structure 10 and so that an exterior cladding layer 22 is applied as the topmost layer bonding to an exterior surface of panel structure 10. For the remainder of this description the bottommost layers of panel structure 10 in casting bed 12 will be referred to as interior layers while the topmost layers of horizontal panel structure will be referred to as the exteriors layers. However, a panel structure 10 may be fabricated with a bottommost layer being an exterior layer and the uppermost layer being an interior layer of the resulting panel.

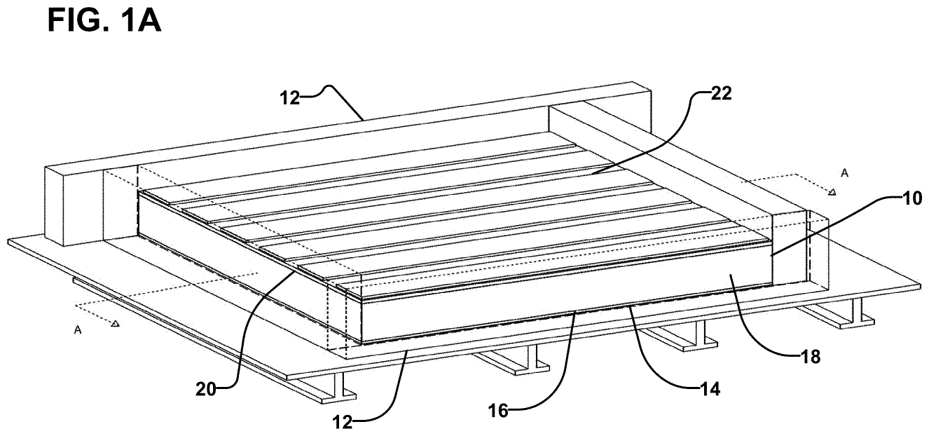

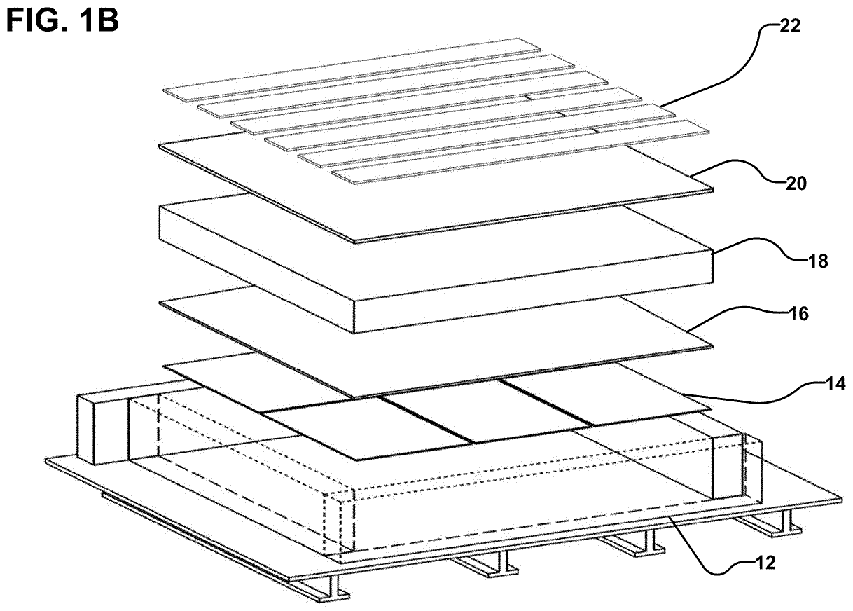

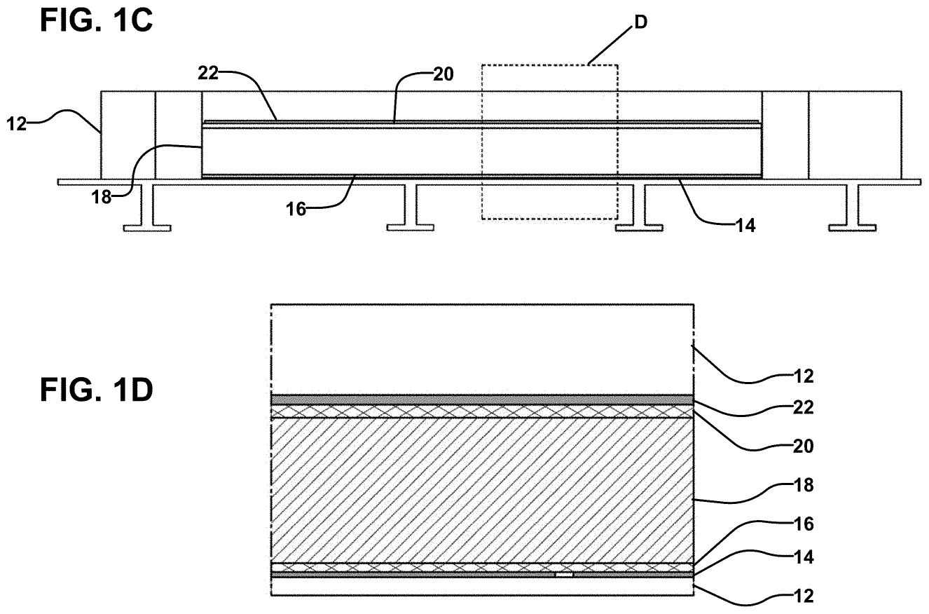

FIGS. 1A through 1D illustrate an exemplary panel structure 10 in a casting bed 12 with both interior cladding layer 14 and exterior cladding layer 22. In this embodiment, panel structure 10 comprises an interior cementitious layer 16, an insulative core 18 and an exterior cementitious layer 20. Each cementitious layer may comprise a weight-bearing or structural layer of panel structure 10.

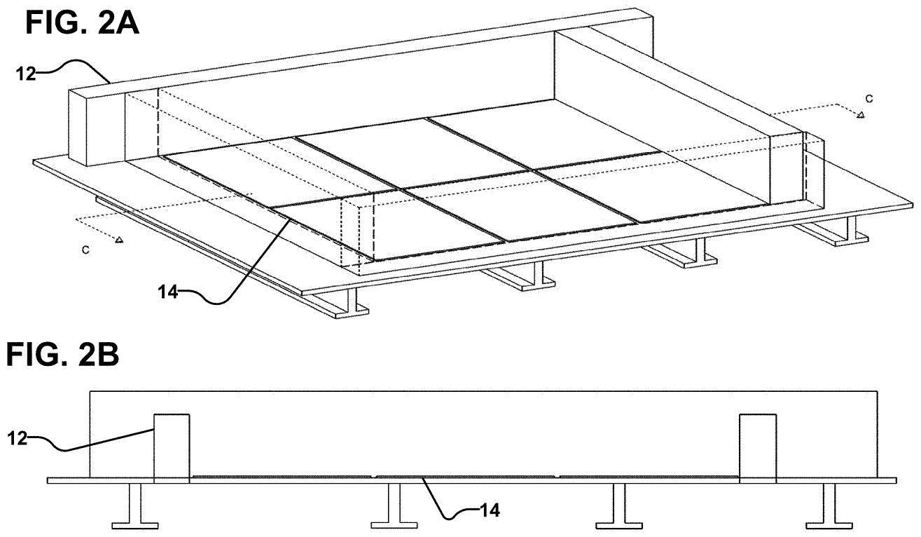

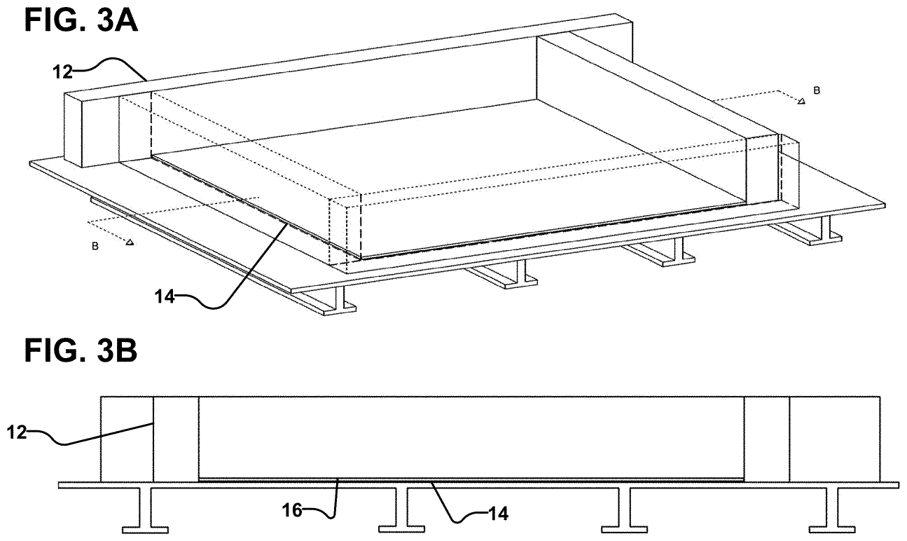

To attach interior cladding layer 14 to panel structure 10, interior cladding layer 14 is laid in casting bed 12, as illustrated in FIGS. 2A and 2B. A cementitious material in an initially liquid or semi-liquid state is then poured onto interior layer 14 to form an interior cementitious layer 16, as in FIGS. 3A and 3B. Walls of casting bed 12 may provide barriers containing cementitious layer 16 while it is poured. In circumstances where cementitious material has a high viscosity or a low flow rate it may be desirable to spread the cementitious material. Spreading of a cementitious material may be a number of means known in the art, such as a hand trowel, float, edger or by agitating the cementitious layer, for example by shaking or vibrating casting bed 12. The cementitious material may chemically adhere, i.e. bond, to interior cladding layer 14 as it sets. In some embodiments one or both of cementitious layers may be between 0.5″ and 2″ thick. In some embodiments cementitious layers may be between 0.75″ and 1.5″ thick. In further embodiments, one or more cementitious layers may be less than 0.5″ thick or more than 2″ thick.

An insulative core 18 may be applied to interior cementitious layer 16 during casting. Insulative core 18 may also bond to interior cementitious layer 16 when the cementitious material sets. Similarly, when exterior cementitious layer 20 is applied over insulative core 18, the cementitious material of exterior cementitious layer 20 may bond to insulative core 18. Other interior layers may be present in or between cementitious layers 16, 20. For example, reinforcing elements (not shown) may be embedded in cementitious layers or be situated within or around insulative core 18.

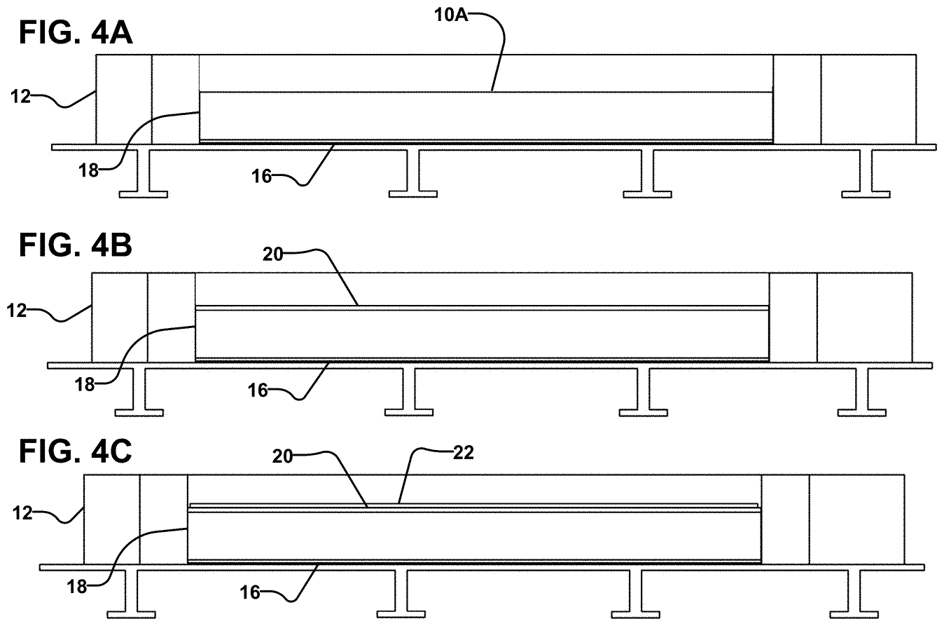

As illustrated in FIGS. 4A and 4B, a cementitious material in an initially liquid or semi-liquid state is poured onto exterior surface 10A of panel 10 to form exterior cementitious layer 20. The cementitious material forming cementitious layer 20 may chemically adhere, i.e. bond, to top surface 10A of panel structure 10, such as an exterior surface of insulative core 18.

In FIGS. 1A through 4C, casting bed 12 defines boundaries limiting the flow or spreading of the cementitious material forming cementitious layers 16, 20. While FIGS. 1A through 4C illustrate panel structure 10 in casting bed 12, casting bed 12 may be removed or substituted with other components. For example, stencils could be laid on top surface 10A of panel structure 10 to define boundaries limiting the flow or spreading of the cementitious material forming exterior cementitious layer 20. In another example, if, prior to setting, the cementitious material of cementitious layer 20 has a high viscosity and low flow rate, it may be applied directly to, and manually spread to cover, the desired portions of top surface 10A. This may be done without any additional material or structure delineating boundaries limiting the flow or spread of the cementitious material. If the viscosity is sufficiently high the cementitious material may set faster than it flows.

After exterior cementitious layer 20 has been applied, exterior cladding layer 22 may be applied directly onto exterior cementitious layer 20, as illustrated in FIG. 4C. In some embodiments exterior cladding layer 22 is applied to exterior cementitious layer 20 under the force of its own weight. In other embodiments, exterior cladding layer 22 may be pressed into exterior cementitious layer 20. Pressing exterior cladding layer 22 into exterior cementitious layer 20 may occur briefly, e.g. to ensure even and continuous contact between the cementitious layer and the cladding layer. Pressing of exterior cladding layer 22 into exterior cementitious layer 20 may also be maintained for longer periods, such as either until the cementitious material has set or until panel structure 10 is demolded from the casting bed. The cementitious material forming exterior cementitious layer 20 may adhere to exterior cladding layer 22. In some embodiments, the cementitious material may chemically adhere to the cladding layer.

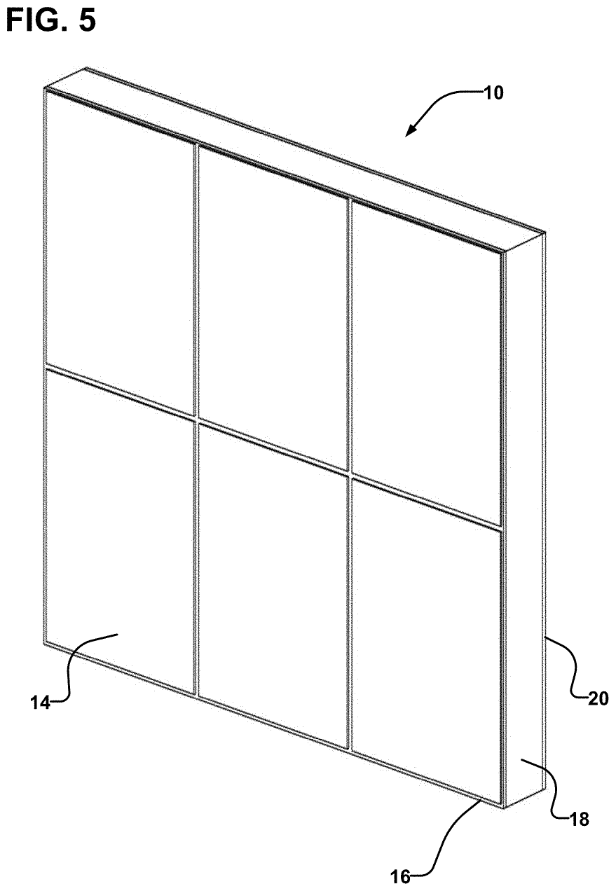

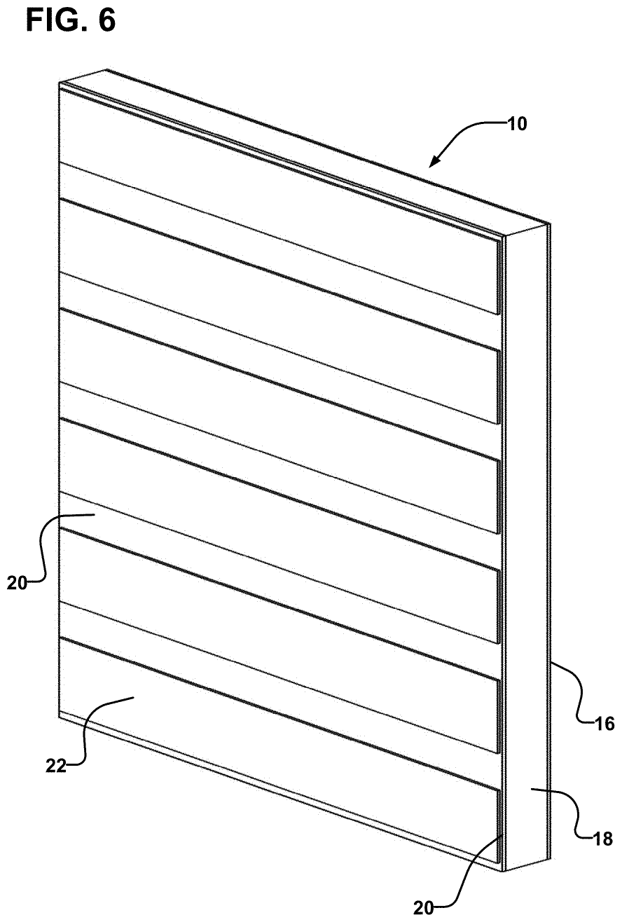

Cladding layers 14, 22 may comprise bricks, or tiles applied in a pattern into a cementitous layer. In such embodiments the cementitious layer may appear between individual bricks or tiles like grout. In some embodiments, cladding layers 14, 22 may be applied as large scale veneers covering all or substantial segments of a panel face. Large scale veneers may for example appear as ornamental stone, brick, marble, or other materials. In some embodiments, cladding may comprise rails or clips which also embed within cementitious materials as cementitious layers 16, 20 set. Interior cladding layer 14 and exterior cladding layer 22 may comprise different materials and may have different appearance, as illustrated in FIGS. 5 and 6.

In some embodiments, cladding layers 14, 22 may comprise functional structures such as solar power panels or solar hot water panels. Some other examples of possible cladding materials include HardiePanel® fiber cement cladding, glass, metal sheets, 3D formed metal sheets, ALUCOBOND® panels, and wood planks. In some embodiments, cladding may comprise chips, flakes, aggregates or beads of material cast into or onto a cementitious material. In some embodiments, cladding layers may be applied to only part of the surface area of a corresponding cementitious layer. An individual cladding layer may also comprise multiple different cladding materials mixed or distributed separately on sections of the panel.

Where the topographies of a surface of panel structure 10 and cladding layers 14, 22 are non-conforming, cementitious material can be applied in a distribution to adhere to cladding layers 14, 22 and adhere to the surface of panel structure 10 across substantially all of the desired surface area of each. As examples, the topographies may be non-conforming where the surface of panel structure 10 is an uneven surface or where a cladding has structures or texture projecting in directions into or away from the plane of panel structure 10. In such embodiments, cementitious material may be manually spread into a desired distribution for cementitious layer 16, 20. In some embodiments where an exterior cladding layer 22 is applied to an exterior cementitious layer 20, cementitious material may be laid in an approximation of the desired distribution and exterior cladding layer 22 laid on top of exterior cementitious layer 20 under pressure. The pressure may cause the cementitious material to flow into a desired distribution conforming to the topographies of exterior cladding layer 22 and the surface of panel structure 10.

After the application of one or more cladding layers to panel structure 10, a fully fabricated panel or substantially fabricated panel may be demolded from casting bed 12 for post-processing. Post-processing may include the application of materials such as paint or acrylic stucco. In some embodiments, post-processing is completed in the factory with the panel set upright, at or near vertical. If cladding layers are applied to both interior and exterior surfaces, post-processing may be applied to one or both surfaces. If cladding is applied to only one of the interior or exterior surfaces, post-processing may also be applied to either or both of the interior and exterior surfaces.

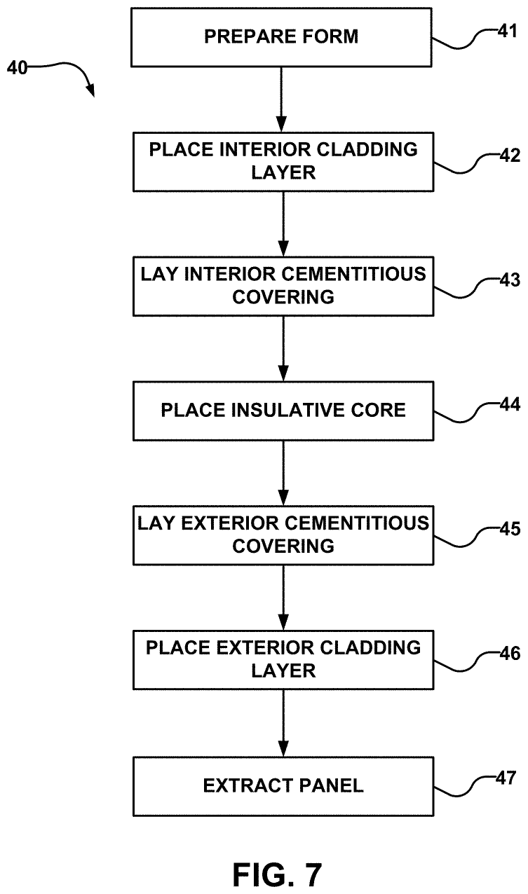

An aspect of the invention provides a method for making prefabricated panels 10 with a cladding layer bonded to the panel 10 by cementitious material in cementitious layers of the prefabricated panel 10. FIG. 7 is a flow chart diagram showing an example method 40 for making such a prefabricated panel 10.

In block 41 a form for casting the panel is prepared. The form may comprise one or more features to assist with extraction of a completed panel. Such features may include rounded interior corners, formwork that may be quickly uncoupled, etc.

In block 42 an interior layer of cladding is placed inside the form. In some embodiments, the layer of cladding may comprise a single sheet covering all or a portion of the surface area of the form. In some other embodiments, the layer of cladding may comprise tiles, chips, flakes or other shapes and materials distributed within the casting form. An individual cladding layer may also comprise multiple different cladding materials mixed or distributed separately on sections of the panel.

In block 43 a first cementitious layer is cast. The first cementitious layer may, for example, be cast by pouring a first layer of cementitious material into the form and positioning a reinforcing member. In some embodiments no adhesive is used to bond the cladding layer to the first cementitious layer; the only material providing the bonding effect is the first cementitious layer.

In block 44 an insulative core is placed inside the form and is directly coupled to the first cementitious layer. As described elsewhere herein, the insulative core may be wet bonded to the first cementitious layer. The insulative core may bond to the first cementitious layer.

In block 45 a second cementitious layer is cast on an opposing face of the insulative core. The second cementitious layer may, for example, be cast by pouring a layer of cementitious material and positioning a reinforcing member. As described above in relation to block 42, the layer of cladding may comprise a single sheet covering all or a portion of the surface area of the form. In some other embodiments, the layer of cladding may comprise tiles, chips, flakes or other shapes and materials distributed within the casting form. An individual cladding layer may also comprise multiple different cladding materials mixed or distributed separately on sections of the panel.

In block 46 a layer of cladding is placed inside the form and is directly coupled to the second cementitious layer by bonding to the second cementitious layer. In some embodiments, the layer of cladding may comprise a single sheet covering all or most of the surface area of the form. In some other embodiments, the layer of cladding may comprise tiles distributed over the second cementitious layer. In some embodiments the layer of cladding may be pressed into the second cementitious layer until the second cementitious layer has set. In some embodiments no adhesive is used to bond the cladding layer to the second cementitious layer; the only material providing the bonding effect is the second cementitious layer.

In block 47 a completed panel is extracted from the form. Preferably the forms may be reused to make additional panels.

### INTERPRETATION OF TERMS

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A prefabricated panel comprising:
an insulative core having first and second opposing faces;
a first cementitious layer covering at least a portion of the first face of the insulative core; and
a cladding layer covering at least a portion of the first cementitious layer, the first cementitious layer bonded to the cladding layer.

2. The prefabricated building panel of claim 1 comprising a second cementitious layer covering at least a portion of the second face of the insulative core.

3. The prefabricated building panel of claim 2 comprising a second cladding layer, the second cladding layer bonded to the second cementitious layer.

4. A method for adhering a cladding layer to a prefabricated panel, the method comprising:
providing a panel structure within a casting bed;
applying a layer of cementitious material to cover at least a portion of a layer of the panel structure;
bonding a cladding material to the layer of cementitious material; and
allowing the cementitious material to set.

5. The method of claim 4 wherein the panel structure comprises:
an insulative core having first and second opposing faces; and
a first cementitious layer covering at least a portion of the first face of the insulative core.

6. The method of claim 5 wherein applying the layer of cementitious material to cover at least the portion of the layer of the panel structure comprises applying a second cementitious layer to at least a portion of the second face of the insulative core.

7. The method of claim 4 wherein the layer of cementitious material comprises a structural layer of the panel structure.

8. The method of claim 4 wherein the step of providing a panel structure within a casting bed comprises the steps of:
casting an interior layer of cementitious material; and
applying an insulative core to the interior layer of cementitious material.

9. The method of claim 4 wherein applying the layer of cementitious material to cover at least the portion of the layer of the panel structure comprises covering the insulative core with an exterior layer of cementitious material.

10. The method of claim 4 wherein applying the layer of cementitious material to cover at least the portion of the layer of the panel structure comprises covering substantially all of a top layer of the panel structure.

11. The method of claim 4 wherein the layer of cementitious material comprises a structural layer of the prefabricated panel.

12. The method of claim 11 wherein the layer of cementitious material is between ⅛″(inches) to 2″ (inches) thick.

13. The method of claim 12 wherein the layer of cementitious material is between 0.5″ (inches) to 1.5″ (inches) thick.

14. The method of claim 4 comprising applying a post-processing layer to the cladding material.

15. The method of claim 14 wherein the post-processing layer comprises paint or acrylic stucco.

16. A method for adhering a cladding layer to a prefabricated panel, the method comprising:
placing a cladding material within a casting bed;
laying a layer of wet cementitious material in the casting bed, the wet cementitious material bonding to the cladding material; and
applying one or more other layers of a panel structure to the wet cementitious material to form a prefabricated panel.

17. A method for adhering cladding to a wall, the method comprising:
applying a layer of cementitious material to an exterior surface of the wall;
adhering a cladding layer to the layer of cementitious material; and
permitting the cementitious material to set.
